(19) United States
(12) Patent Application Publication
(10) Pub. No.: US 2013/0275173 A1
(43) Pub. Date: Oct. 17, 2013

(54) Real-Time Publishing of Finite Schedules and Real-Time Response to Schedule Changes

(71) Applicant: Lenrick Johnston, Berkeley, CA (US)

(72) Inventor: Lenrick Johnston, Berkeley, CA (US)

(73) Assignee: BIOPRODUCTION GROUP, Berkeley, CA (US)

(21) Appl. No.: 13/444,779

(22) Filed: Apr. 11, 2012

(51) Int. Cl. G06Q 10/06

(52) U.S. Cl. CPC G06Q 10/06312
USPC 705/7.22

(57) ABSTRACT

A method for real-time publishing of a finite schedule that includes a plurality of activities and a plurality of resources is presented. The method utilizes at least one master schedule derived from an output of the finite schedule and at least one published schedule associated with the at least one master schedule. The at least one master schedule includes at least one master activity instance and the at least one published schedule includes at least one published activity instance. The method creates a schedule mapping table and an activity instance-mapping table. The schedule mapping table stores at least one relationship between the at least one master schedule and the at least one published schedule. Furthermore, the method updates the finite schedule and communicates schedule deviations in real-time with the finite schedule.

### BACKGROUND OF THE INVENTION

1. Technical Field of the Invention

The present invention relates in general to finite scheduling of processes in a manufacturing or operations setting. More specifically, the present invention provides a method for publishing and updating one or a series of finite schedules that includes a plurality of activities and resources.

2. Description of the Related Art

Finite scheduling is a method of constraint-based scheduling that is used by many facilities and businesses to plan activities and resources. The goal of finite scheduling is to produce a feasible schedule for one or more resources that includes one or a series of activities that must be performed. In finite scheduling a best sequence is identified for optimal assignment of limited resources and activities to complete a set of tasks in a limited time. Moreover, in finite scheduling the available resources and activities are allocated to optimally perform a set of activities.

The conventional finite scheduling method works through a master schedule to locate the constraints or bottlenecks during a series of planned activities in a given process. In this way, the constraint based finite scheduling method attempts to balance the constraints or bottlenecks with the normal functioning processes and allocate the planned activities to specific resources. The output from the finite scheduling of a process having a series of activities and multiple resources is an ordered list of tasks for each resource, along with start times, durations and end times. Finite schedules may also include other information such as a description, associated resources, and other data that may provide more detail about the task to be performed such as a lot number or batch identifier. Such information is then used to determine what the resources do over the period of time considered.

Various methods exist as means to optimize scheduling of resources and the activities of a manufacturing or operations setting. Of particular note is U.S. Pat. No. 7,904,192 issued to Chua et al. on Mar. 8, 2011, and which describes a method, device, and computer-readable medium for finite capacity scheduling. Heuristic rules are applied in two integrated stages: Job Prioritization and Machine Selection. During Job Prioritization (“JP”), jobs are prioritized based on a set of JP rules, which are machine independent. During Machine Selection (“MS”), jobs are scheduled for execution at specific machines that are deemed to be best suited based on a set of MS rules. The two-stage approach allows scheduling goals to be achieved for performance measures relating to both jobs and machines. For example, machine utilization may be improved while product cycle time objectives are still met. Two user-configurable options, the scheduling model (job shop or flow shop) and the scheduling methodology (forward, backward, or bottleneck) govern the scheduling process. A memory may store a three-dimensional, linked, data structure for use in scheduling work orders for execution at machines assigned to work centers.

U.S. Pat. No. 7,733,873, issued to Bullis et al. on Jun. 8, 2010 describes a system that indicates which frame should next be removed by a scheduler from flow queues within a network device, such as a router, network processor, or other similar devices. The system comprises a search engine that searches a set of calendars under the control of a Finite State Machine (FSM), a current pointer, input signals from an array, and a clock line providing current time. The results of the search are loaded into a Winner Valid array and a Winner Location array. A final decision logic circuit parses information in the Winner Valid array and Winner Location array to generate a final Winner Valid Signal, the identity of the winning calendar, and the winning location. Winning is used to define the status of the calendar in the calendar status array selected as a result of the search process that is executed on a plurality of calendars in the calendar status array.

U.S. Pat. No. 5,233,533, issued to Edstrom et al. on Aug. 3, 1993 discloses a scheduling software program to provide date and time allocation of resources to a sequence of processes for manufacturing a desired item. Scheduling is performed by a backward-forward method and alternatively by a backward jump forward jump method to meet a requested due date. Resources are dynamically allocated to satisfy processes according to pre-established rules for allocation. Resources are allocated in certain amounts or in a predetermined pattern so as to minimize waste or left over amounts of the resource. To allocate certain resources, the purchase or production of the resource is scheduled first.

It has been seen that finite scheduling is used in many industries for preparing detailed scheduling solutions that may be utilized to schedule services and operations, taking into account the existing resource load. It allows a better or optimal sequencing of activities, higher or more efficient utilization of resources, and improved overall facility efficiency. Even though the concept behind finite scheduling may appear quite simple, the implementation of finite scheduling in manufacturing or operations is complex since the scheduling process must account for a plurality of real world events. In order to adjust an operation with respect to changes in any of the events of the manufacturing or operations cycle, it must be possible to reschedule re-plan the related events. Such re-planning requires an explicit knowledge of what is happening in the process in order to update the finite schedule. This may be difficult if the scheduler or scheduling tool is not directly observing the process. This issue is compounded by the fact that, when such unplanned events occur, the impact of those events may not be perfectly understood even by those directly observing the process. Such details make re-planning a difficult and time-consuming process.

Hence, it can be seen that there is a need for an improved method for creating a finite schedule that provides a means to allocate tasks or activities to resources while ensuring that the resulting schedule remains a feasible one. Such a method would provide a distributed mechanism for the finite schedule that is both automated as well as real-time. Further, the method provides a communication mechanism for people in a manufacturing or operations environment, to communicate schedule deviations back to the finite schedule in real time. Such a method would allow many people to instantly see the changes to a schedule in real time and would provide a means to incorporate the impact of such changes into the finite schedule. Moreover, the needed finite scheduling method would allow much of the planning process to be automated by using software that can automatically consider the many combinations and alternatives of allocations of resources to activities as well as potential orderings of events. Furthermore, the end users in the events of the manufacturing or operations setting would have the provision to see the final published schedules and one or more of said end users may change parameters in one or more activities or processes and in one or more schedules. The finite scheduling software maintains the ability to retrieve the stored changes entered by one or more end users and changes the finite schedule of one or more events accordingly in order to incorporate each change. Such a method would increase the visibility of schedulers and schedules to changes to operating conditions and allow faster sensing and responding to changes that are not directly visible to those performing the finite scheduling task.

### SUMMARY OF THE INVENTION

To minimize the limitations found in the prior art, and to minimize other limitations that will be apparent upon the reading of the attached specification, the present invention provides a method for real-time publishing of a feasible finite schedule. No claims are made about the method of generation of the finite schedule, only that a feasible schedule exists. ‘Feasible’ in this setting means an allocation of tasks (or activities) to resources or machines that does not break rules established for the operation of any resource or machine. The finite schedule includes a plurality of activities and a plurality of resources. The method includes at least one master schedule ‘a’, where a=1 . . . A and at least one published schedule ‘b’, where b=1 . . . B. The at least one master schedule includes at least one master activity instance iₐ, where iₐ=1 . . . Iₐ and the at least one published schedule includes at least one published activity instance i_{b}, where i_{b}=1 . . . I_{b}. While typically master schedules will correspond to each resource in a facility—one master and published schedule for each resource—the invention is not limited to this constraint, and there may exist multiple master and published schedules for each resource, or multiple resources for each master or published schedule.

The disclosed method creates a schedule mapping table that stores at least one relationship between the at least one master schedule ‘a’ and the at least one published schedule ‘b’. The method further includes an activity instance mapping table that includes information such as but not limited to the name of the master schedule or its location in a computer network to find the at least one published schedule ‘b’. The method defines at least one property ‘p’, where p=1 . . . P for the at least one master activity instance iₐ and the at least one published activity instance i_{b}. The at least one property ‘p’ includes information such as but not limited to start time, end time, duration, description, resources, location, number of batches, or any other property that is descriptive of the at least one master activity instance iₐ and the at least one published activity instance i_{b}.

The publishing process is performed independently for each master schedule ‘a’. The method iterates over each of the at least one master schedule ‘a’. The presence of the at least one published schedule ‘b’ is checked in the schedule mapping table and if the at least one published schedule ‘b’ does not exist in the schedule mapping table then a new published schedule is created. The method iterates over each of the at least one master activity instance iₐ and over each of the at least one published schedule ‘b’ to determine the presence of the at least one published activity instance i_{b} in the at least one published schedule ‘b’ by searching in the activity instance mapping table. The method creates a new published activity instance if the at least one published activity instance i_{b} does not exist in the at least one published schedule ‘b’. After the creation of the new published activity instance, an entry iₐ/i_{b} is stored in the activity instance mapping table for the at least one published schedule ‘b’. The method iterates over each of the at least one property ‘p’ to determine if the at least one property of the at least one master activity instance iₐ matches with the at least one published activity instance i_{b}. If there is no match, then the at least one published schedule ‘b’, the at least one published activity instance i_{b} and the at least one property ‘p’ are altered to match the at least one master schedule ‘a’ and an entry iₐ/i_{b} is registered as not valid in the activity instance mapping table. Finally, if the at least one property ‘p’ of the at least one master activity instance iₐ matches with the at least one published activity instance i_{b} then the entry iₐ/i_{b} in the activity instance mapping table is registered as valid.

In another aspect of the present invention, in the method for updating the finite schedule, after registering the entry iₐ/i_{b} in the activity instance mapping table as valid, the method iterates over each of the at least one published schedule ‘b’. For each value of the published schedule the method iterates over the at least one published activity instance i_{b} and determines whether the at least one master activity instance iₐ is not registered as valid and exists in the at least one published schedule ‘b’. The at least one published activity instance i_{b} is removed from the activity instance mapping table and checks if the at least one published activity instance i_{b} is flagged as valid. If the at least one master activity instance iₐ is flagged as not valid then the published activity instance i_{b} is deleted from the at least one published schedule b and the at least one published activity instance i_{b} is removed from the activity instance mapping table. After executing these steps for each master schedule ‘a’, there will be a list of published schedule and a series of activity instance mapping tables, one for each published schedule ‘b’.

In yet another aspect of the present invention, a method for communicating at least one schedule deviation with the finite schedule is illustrated. The method includes two main phases. In the first phase each published schedule b=1 . . . B is examined and in the second phase the output of that step in the context of each of the at least one master schedule a=1 . . . A is examined. The method preferably begins by iterating over each of the at least one published schedule b, b=1 . . . B and checks for the presence of an equivalent at least one master schedule ‘a’ in the schedule mapping table. The at least one published schedule is deleted if the at least one master schedule ‘a’ does not exist. The process then iterates over each of the at least one published activity instance i_{b} in the at least one published schedule if the at least one master schedule ‘a’ exists and iterates over each of the at least one master schedule a, a=1 . . . A to determine if the entry iₐ/i_{b} exists in the at least one master schedule ‘a’ by checking the activity instance mapping table. The at least one published activity instance i_{b} is deleted from the at least one published schedule ‘b’ if the entry iₐ/i_{b} does not exist in the at least one master schedule ‘a’. If the entry ia/ib exists in the at least one master schedule ‘a’ then the process iterates over each of the at least one property ‘p’, where p=1 . . . P and determines if the at least one property ‘p’ matches for the at least one master activity instance iₐ and the at least one published activity instance i_{b}. If there is no match for the property ‘p’ then the process stores the at least one difference in the property of the at least one master activity instance iₐ and the at least one published activity instance i_{b} in a difference table Dₐ.

In the second phase of the method, the process starts by iterating over each of the at least one master schedule ‘a’ and further iterates over each of the at least one master activity instance iₐ in the at least one master schedule ‘a’. The process again iterates over each of the at least one property ‘p’ to collect the at least one difference stored in the difference table Dₐ and performs at least one action based on the collected difference.

It is a first objective of the present invention to provide a method for real-time publishing of a finite schedule utilizing at least one master schedule and at least one published schedule.

It is a second objective of the invention to provide a method for updating the finite schedule.

A third objective of the invention is to provide a method for communicating at least one schedule deviation with the finite schedule.

Yet another objective of the invention is to provide at least one master activity instance and at least one published activity instance.

Still another objective of the invention is to provide a schedule mapping table and an activity instance-mapping table.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention. Thus, in the interest of clarity and conciseness, the drawings are generalized in form, wherein:

FIG. 1 is a flowchart of a method for real-time publishing of a finite schedule of the present invention;

FIG. 2 is a flowchart of a method for real-time updating of the finite schedule of the present invention;

FIG. 3 is a flowchart illustrating a first phase of a method for communicating at least one schedule deviation with the finite schedule of the present invention;

FIG. 4 is a flowchart illustrating a second phase of a method for communicating at least one schedule deviation with the finite schedule of the present invention;

FIG. 5 is a diagrammatic representation of a schedule mapping table;

FIG. 6 is a diagrammatic representation of an activity instance mapping table; and

FIGS. 7A-7J illustrate diagrammatic representation of examples for the allocation of resources to activities by the finite schedule.

### DETAILED DESCRIPTION OF THE INVENTION

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below. For clarity the letters a, b, and p, may at times be placed in single quotes as ‘a’, ‘b’, and ‘p’.

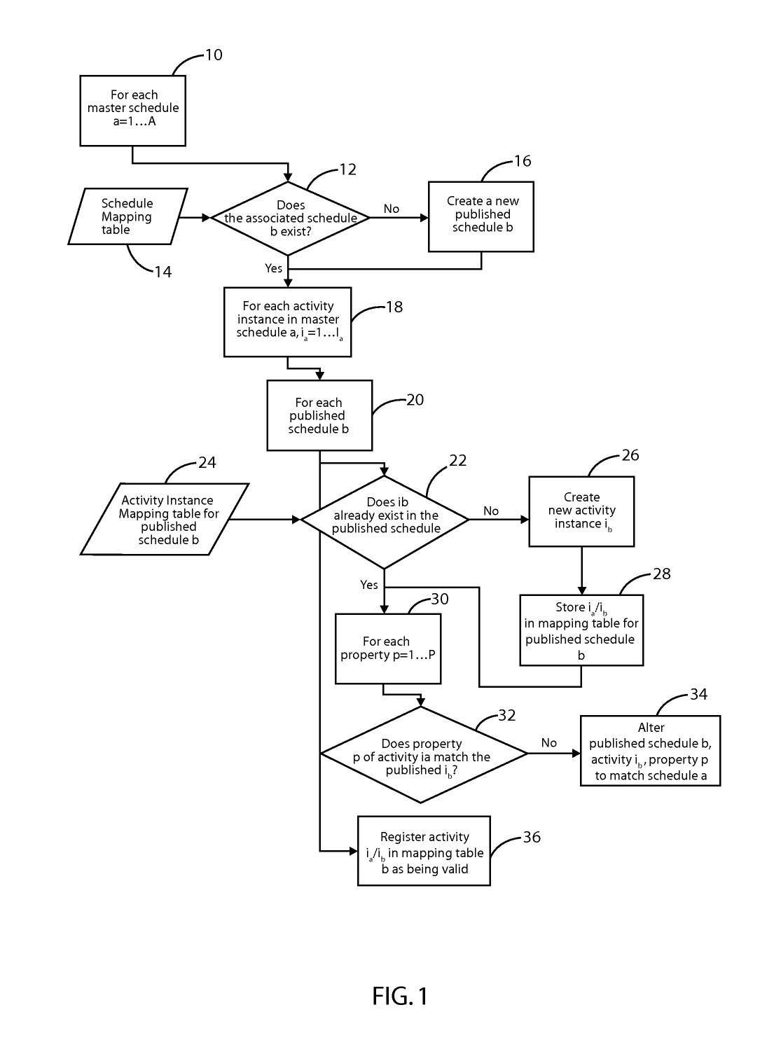

FIG. 1 is a flowchart of a method for real-time publishing of a finite schedule of the present invention. The finite schedule includes a plurality of activities and a plurality of resources. In the method, at least one master schedule a, a=1 . . . A is derived from an output of the finite schedule. The at least one master schedule includes at least one master activity instance iₐ, iₐ=1 . . . Iₐ associated with the at least one master schedule. The at least one master schedule ‘a’ is associated with at least one published schedule b, b=1 . . . B that includes at least one published activity instance i_{b}, i_{b}=1 . . . I_{b}.

The method creates a schedule mapping table and an activity instance-mapping table. The schedule mapping table stores at least one relationship between the at least one master schedule ‘a’ and the at least one published schedule ‘b’. The schedule mapping table may include information including but not limited to the name of the master schedule or its location in a computer network to find the at least one published schedule ‘b’. The activity instance mapping table includes at least one unique identifier to map the at least one master activity instance iₐ and the at least one published activity instance i_{b} in the at least one master schedule ‘a’ and the at least one published schedule ‘b’.

The publishing of the finite schedule allows the at least one master schedule to communicate with devices including but not limited to a computer, a smart phone, a mobile phone and a mechanism adaptable to view the at least one master schedule utilizing E-mail/Calendar platforms. The E-mail/Calendar platforms may include Microsoft Exchange Server, Google's Gmail platform, Blackberry, and other suitable platforms. Each activity of the finite schedule includes a start date and time, end date and time, an activity name, the plurality of resources and many other descriptions about the activities.

The method defines at least one property p, p=1 . . . P for the at least one master activity instance iₐ and the at least one published activity instance i_{b}. The at least one property ‘p’ may include information such as start time, end time, duration, description, resources, location, number of batches, or any other property that is descriptive of the at least one master activity instance iₐ and the at least one published activity instance i_{b}.

The publishing process is performed independently for each master schedule ‘a’. The method begins by iterating over each of the at least one master schedule a, a=1 . . . A as shown in block 10. All the remaining steps in the method may be iteratively performed until a=A. As shown in block 12, presence of the at least one published schedule ‘b’ is checked in the schedule mapping table indicated at block 14. If the at least one published schedule ‘b’ does not exist in the schedule mapping table then a new published schedule is created as depicted in block 16.

The method iterates over each of the at least one master activity instance iₐ, iₐ=1 . . . Iₐ as indicated at block 18. For instance, when iₐ=1, the method may execute the steps indicated at blocks 22, 24, 26, 28, 30, 32, 34 and 36. The method may execute these steps until the at least one published schedule ‘b’ becomes B as shown in block 20. The loop indicated at block 18 iterates till the value of iₐ becomes Iₐ. Referring to block 22, the method determines the presence of the at least one published activity instance i_{b} in the at least one published schedule ‘b’ by searching in the activity instance mapping table as depicted at block 24.

A new published activity instance i_{b} is created as shown in block 26 if the at least one published activity instance i_{b} does not exist in the at least one published schedule ‘b’. After the creation of the new published activity instance, an entry iₐ/i_{b} is stored in the activity instance mapping table for the at least one published schedule ‘b’ as depicted at block 28. Then, the method iterates over each of the at least one property p, p=1 . . . P as shown in block 30 to determine if the at least one property of the at least one master activity instance iₐ matches with the at least one published activity instance i_{b} as indicated at block 32. If there is no match, then the at least one published schedule ‘b’, the at least one published activity instance i_{b} and the at least one property ‘p’ are each altered to match with the at least one master schedule a as shown in block 34 and an entry iₐ/i_{b} is registered as not valid in the activity instance mapping table. Finally, if the at least one property ‘p’ of the at least one master activity instance iₐ matches with the at least one published activity instance i_{b} then the entry iₐ/i_{b} in the activity instance mapping table is registered as valid as shown in block 36.

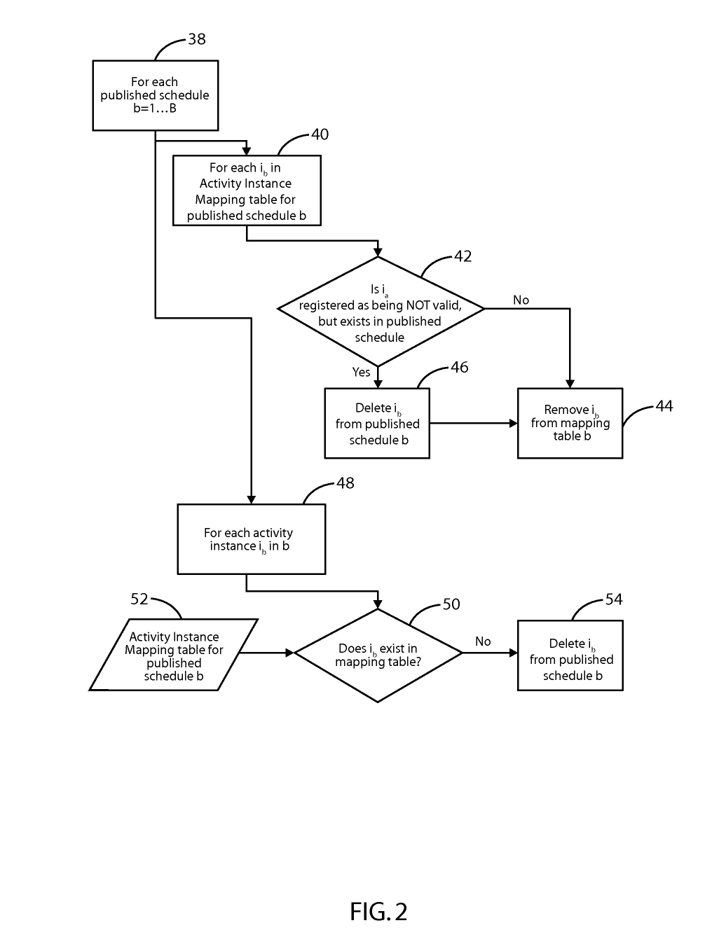

Referring to FIG. 2, a flowchart for updating the finite schedule is illustrated. After registering the entry iₐ/i_{b} in the activity instance mapping table as valid as discussed in the text related to FIG. 1, the method iterates over each of the at least one published schedule b, b=1 . . . B as shown in block 38. For instance, when b=1, the method may execute the steps indicated at blocks 40, 42, 44 and 46. The method may execute these steps until the at least one published activity instance i_{b} becomes I_{b} as shown in block 40. The loop indicated at block 38 iterates till the value of ‘b’ becomes B.

As indicated in block 42, the method determines whether the at least one master activity instance iₐ is not registered as valid and exists in the at least one published schedule ‘b’. The at least one published activity instance i_{b} is removed from the activity instance mapping table as shown in block 44 if the at least one published activity instance i_{b} is flagged as valid. And if the at least one master activity instance iₐ is flagged as not valid then the published activity instance i_{b} is deleted from the at least one published schedule ‘b’ as indicated at block 46 and the at least one published activity instance i_{b} is removed from the activity instance mapping table as shown in block 44.

After executing these steps for each master schedule ‘a’, there will be a list of published schedule ‘b’ and a series of activity instance mapping tables, one for each published schedule ‘b’. All entries in each master schedule ‘a’ are in each published schedule ‘b’. However, it is not mandatory that the published schedule ‘b’ does not contain extraneous entries that are not in master schedule ‘a’.

The above discussed method may include an optional step wherein the method iterates for each of the at least one published activity instance i_{b} as shown in block 48 to check the presence of the at least one published activity instance i_{b} as indicated at block 50 using the activity instance mapping table 52. If it does not exist, the method deletes i_{b} from the at least one published schedule as shown in block 54 since it should not exist in the activity instance mapping table. This step ensures that any unwanted additions to the at least one published schedule ‘b’ that have occurred outside this process are not kept. There are some cases where a user may wish to omit this step, such as when the user has manually added activity instances outside the scope of the finite schedule, and which the user desires to retain in the published schedule. In such a case, this optional step is omitted.

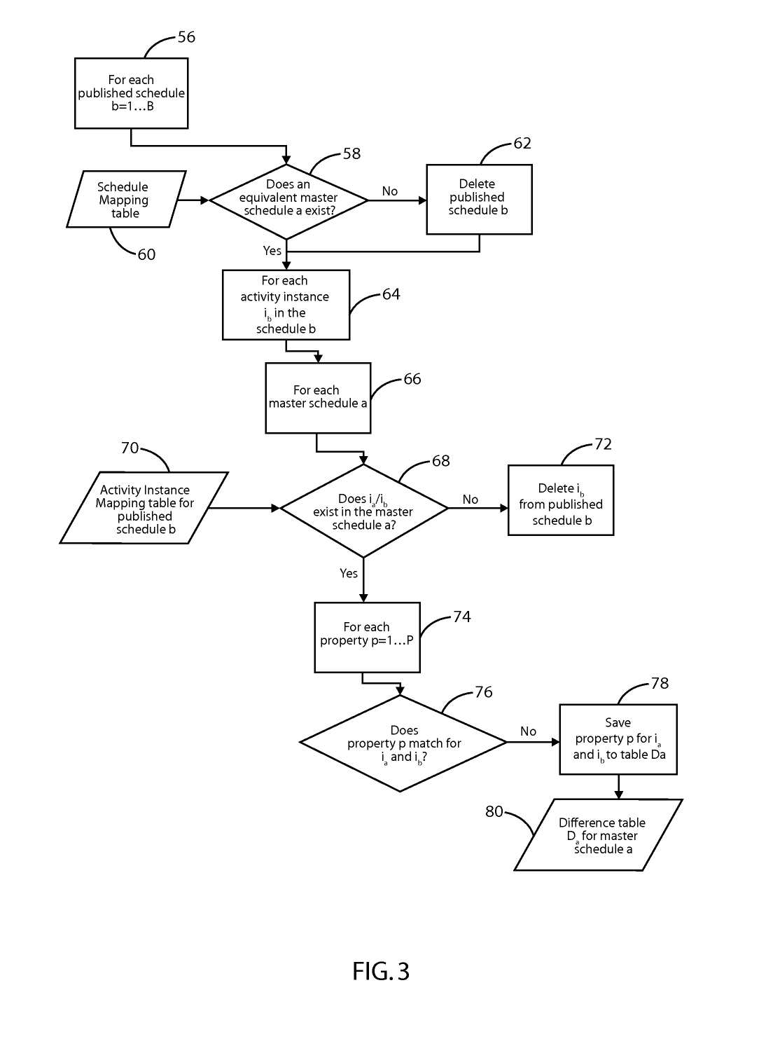

With reference to FIG. 3, a flowchart illustrating a first phase of a method for communicating at least one schedule deviation with the finite schedule is shown. This method is hereinafter termed a reconciliation process. The reconciliation process includes two main phases. The first phase examines each published schedule b=1 . . . B and the second phase examines the output of that step in the context of each of the at least one master schedule a=1 . . . A. The reconciliation process starts by iterating over each of the at least one published schedule b, b=1 . . . B as shown in block 56 and checks for the presence of an equivalent at least one master schedule ‘a’ in the schedule mapping table 60 as shown in block 58. The at least one published schedule ‘b’ is deleted as indicated at block 62 if the at least one master schedule ‘a’ does not exist. The process then iterates over each of the at least one published activity instance i_{b} in the at least one published schedule ‘b’ if the at least one master schedule ‘a’ exists as shown in block 64 and iterates over each of the at least one master schedule a, a=1 . . . A as depicted in block 66 to determine if the entry iₐ/i_{b} exists in the at least one master schedule ‘a’ as shown in block 68 by checking the activity instance mapping table 70. For instance, when i_{b}=1, the method may execute the steps indicated at blocks 66, 68, 70, 72, 74, 76, 78 and 80. The method executes these steps until the at least one master schedule ‘a’ becomes ‘A’ as shown in block 66. The for loop indicated at block 64 iterates until the value of i_{b} becomes I_{b}.

The at least one published activity instance i_{b} is deleted from the at least one published schedule ‘b’ if the entry iₐ/i_{b} does not exist in the at least one master schedule ‘a’ as shown in block 72. If the entry ia/ib exists in the at least one master schedule ‘a’ then the process iterates over each of the at least one property p, p=1 . . . P as shown in block 74 and determines if the at least one property p matches for the at least one master activity instance iₐ and the at least one published activity instance i_{b} as indicated at block 76. If there is no match for the property ‘p’ then the process stores the at least one difference in the property of the at least one master activity instance iₐ and the at least one published activity instance i_{b} in a difference table Dₐ 80 as shown in block 78.

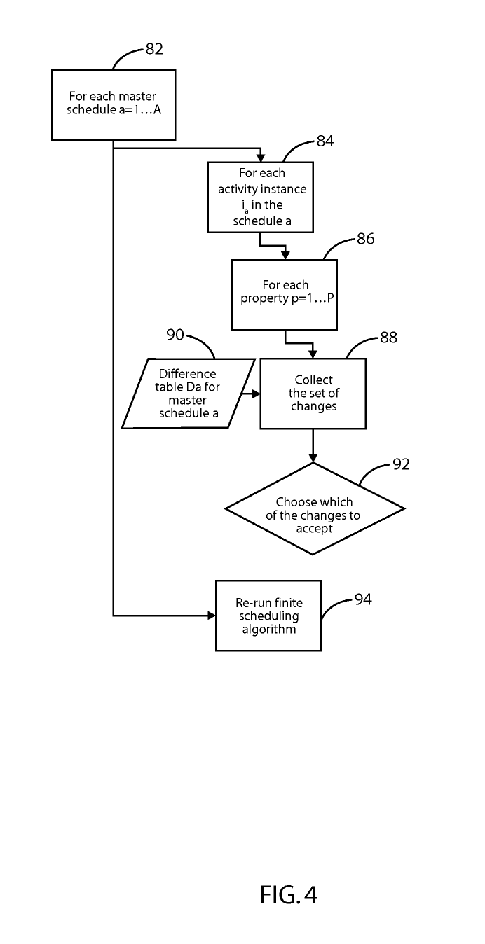

FIG. 4 shows the second phase of the reconciliation process. The process initiates by iterating over each of the at least one master schedule ‘a’ as indicated at block 82 and further iterates over each of the at least one master activity instance iₐ in the at least one master schedule ‘a’ as depicted in block 84. The process again iterates over each of the at least one property ‘p’ as shown in block 86 to collect the at least one difference stored in the difference table Dₐ 90 as shown in block 88 and perform at least one action based on the collected difference as indicated at block 92. For example, when iₐ=1, the method executes the steps indicated at blocks 86, 88, 90 and 92. The method executes these steps until the at least one property ‘p’ becomes P as shown in block 86. The loop indicated at block 84 iterates till the value of iₐ becomes Iₐ.

The at least one action may include three cases. In the first case, no difference is stored in the difference table Dₐ. Therefore, no change needs to be made to the at least one master schedule ‘a’ since no proposed change has been issued from any published schedule ‘b’.

In the second case, there will be only one published schedule ‘b’ that shows one difference from the master schedule ‘a’ and that difference may be accepted or may be rejected. The difference is accepted by updating the master activity instance iₐ with the data from the published activity instance i_{b} and the difference is rejected by deleting the activity instance-mapping table.

In the third case, there will be multiple published schedules ‘b’, with one or more of them being updated. The process may accept one of the proposed differences or may reject the differences. The difference is accepted by updating the at least one master activity instance iₐ with the data from the chosen published activity instance i_{b} and the difference is rejected by deleting all master activity instances iₐ from all activity instance mapping tables. After executing these steps, the finite scheduling algorithm may need to be re-applied to re-establish feasibility for the finite schedule as shown in block 94.

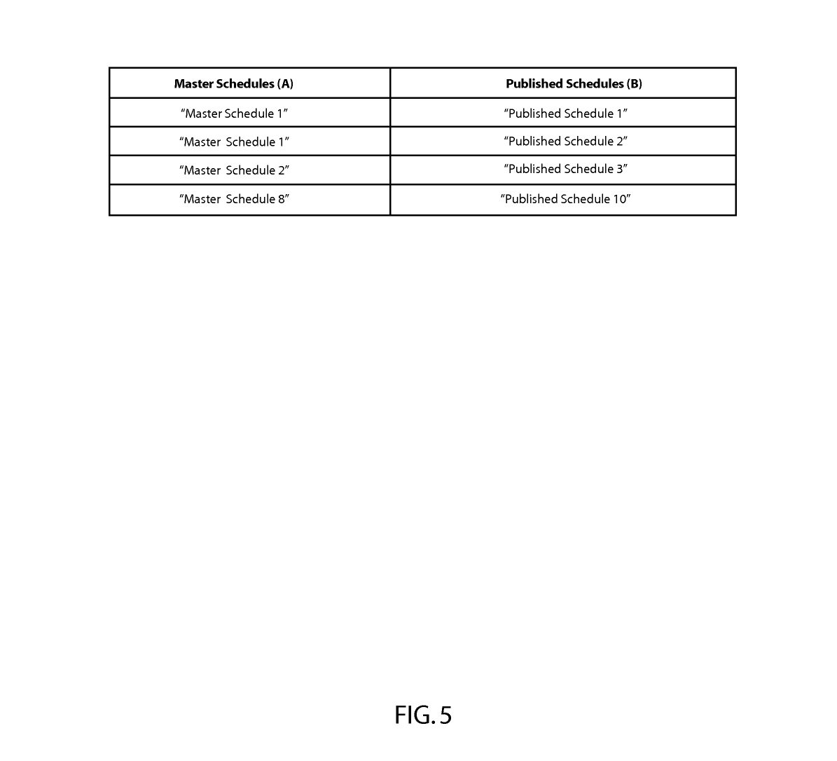

FIG. 5 shows a diagrammatic representation of a schedule-mapping table. The relationship between the at least one published schedule and the at least one master schedules is stored in the schedule mapping table. The schedule-mapping table shows which published schedules ‘b’ relate to a particular master schedule ‘a’. The schedule-mapping table may include information such as the name of the schedule or its location in a computer network to find a particular published schedule ‘b’. Referring to FIG. 5, Published Schedule 1 and Published Schedule 2 are related to Master Schedule 1. Similarly, Published Schedule 3 is related to Master Schedule 2 and the Published Schedule 10 is related to Master Schedule 8.

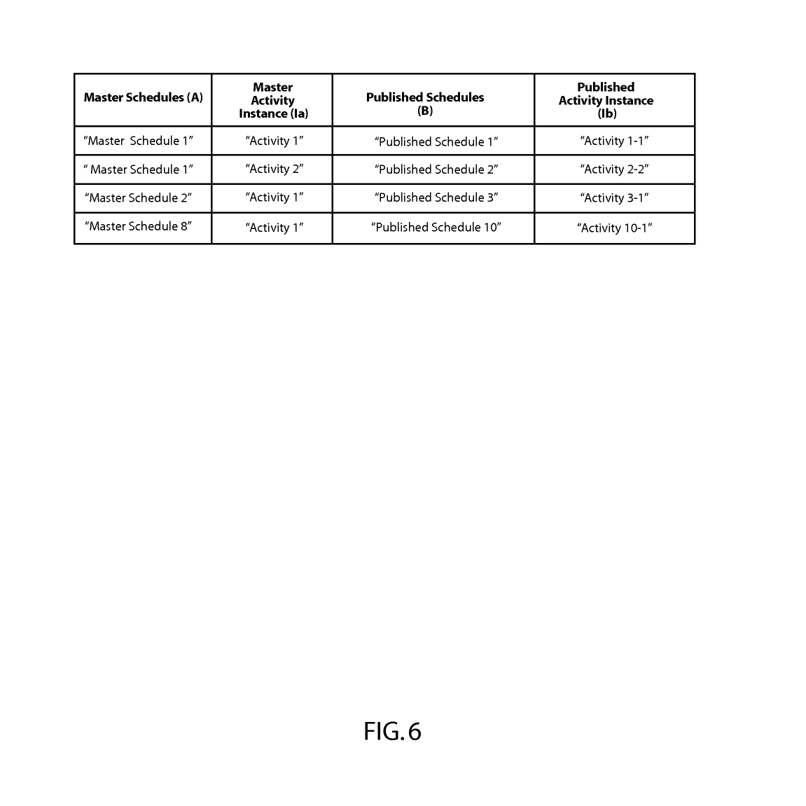

FIG. 6 is a diagrammatic representation of the activity instance-mapping table. There will be an activity instance-mapping table for each master schedule ‘a’. The unique identifiers of the activity instance-mapping table are used to map a particular activity instance to its location on one or a multiplicity of published schedules ‘b’. The activity instance mapping table uniquely defines the activity instances in both the master and published schedules and allows a method for their properties to be retrieved during the algorithm execution.

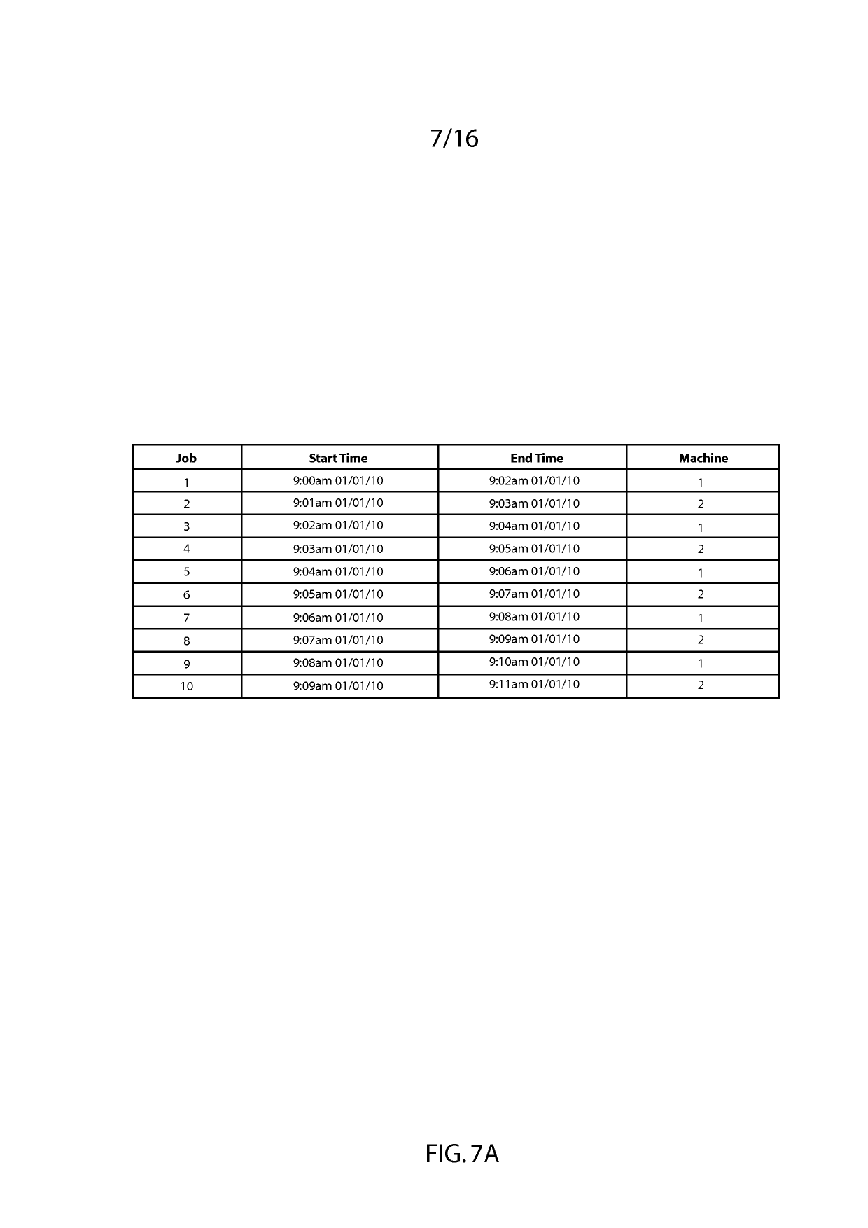

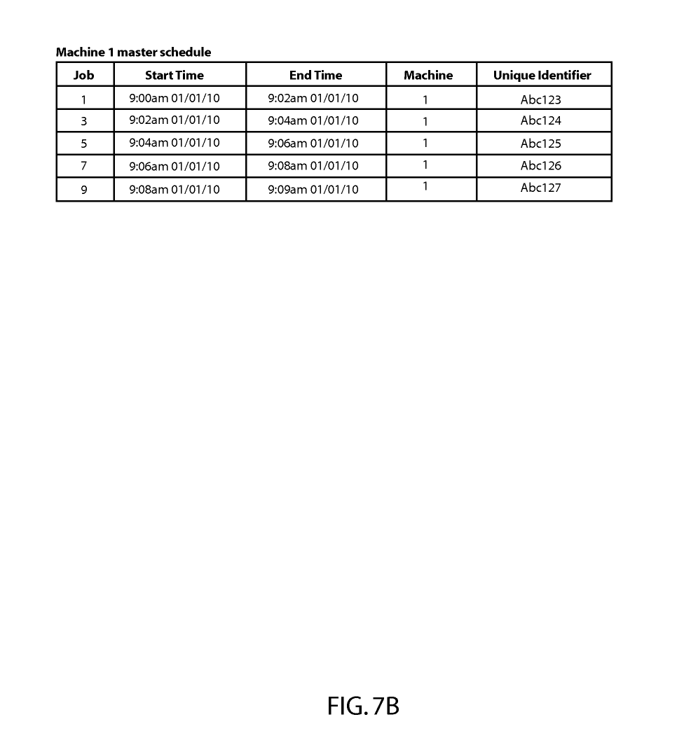

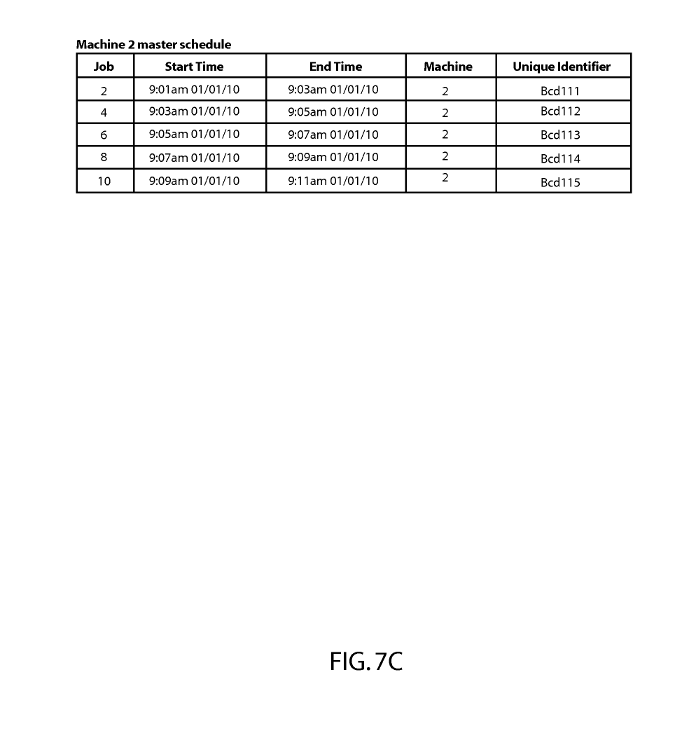

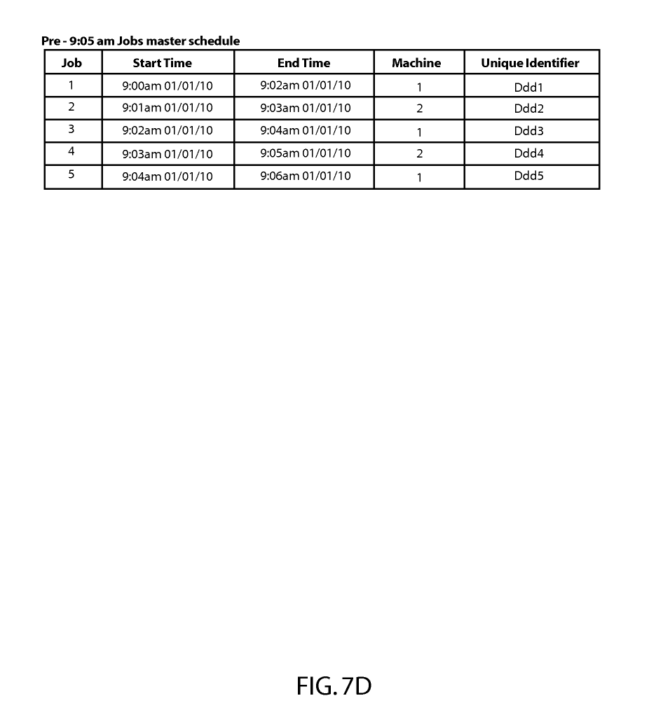

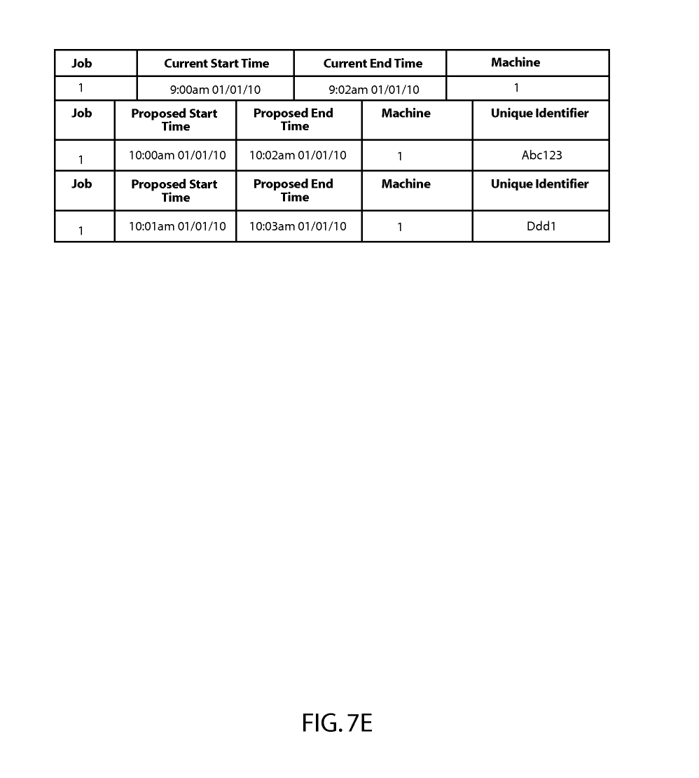

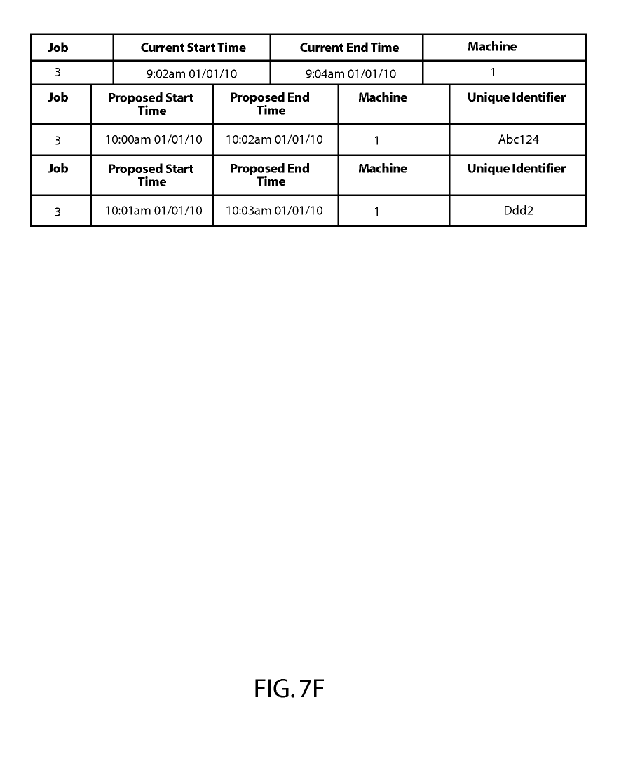

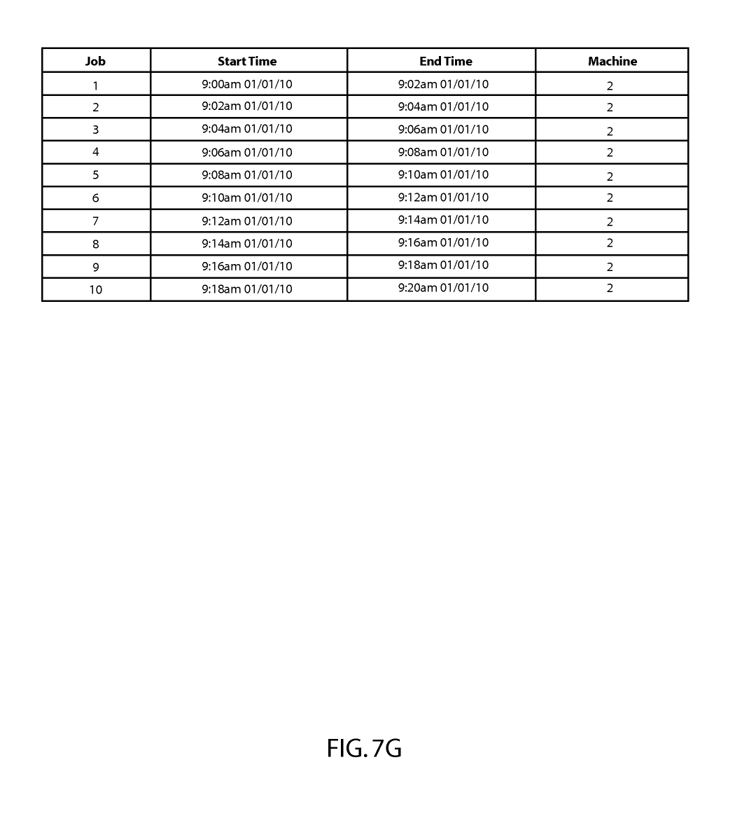

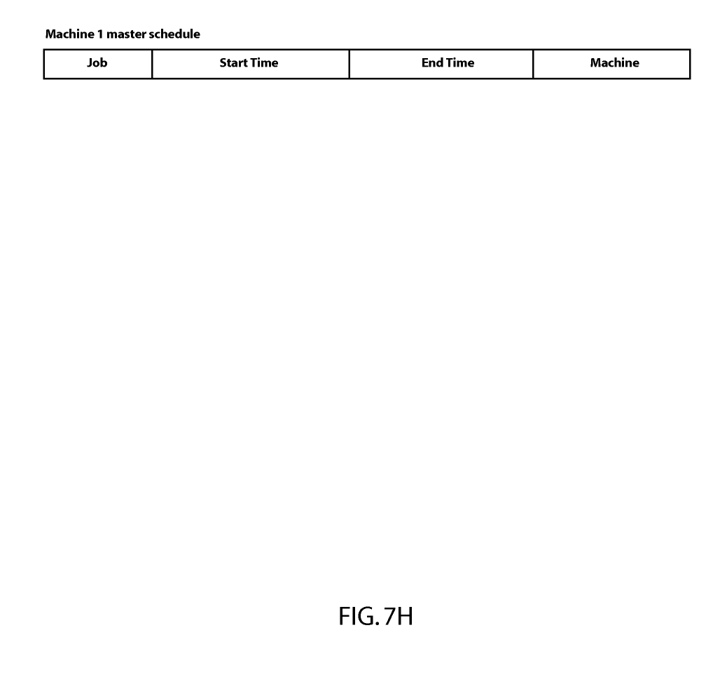

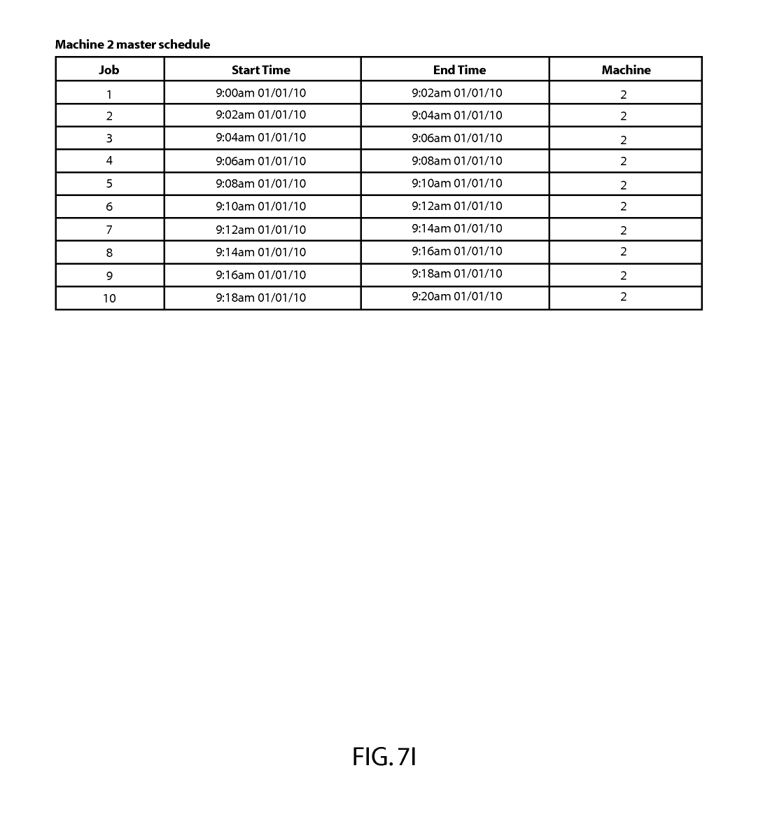

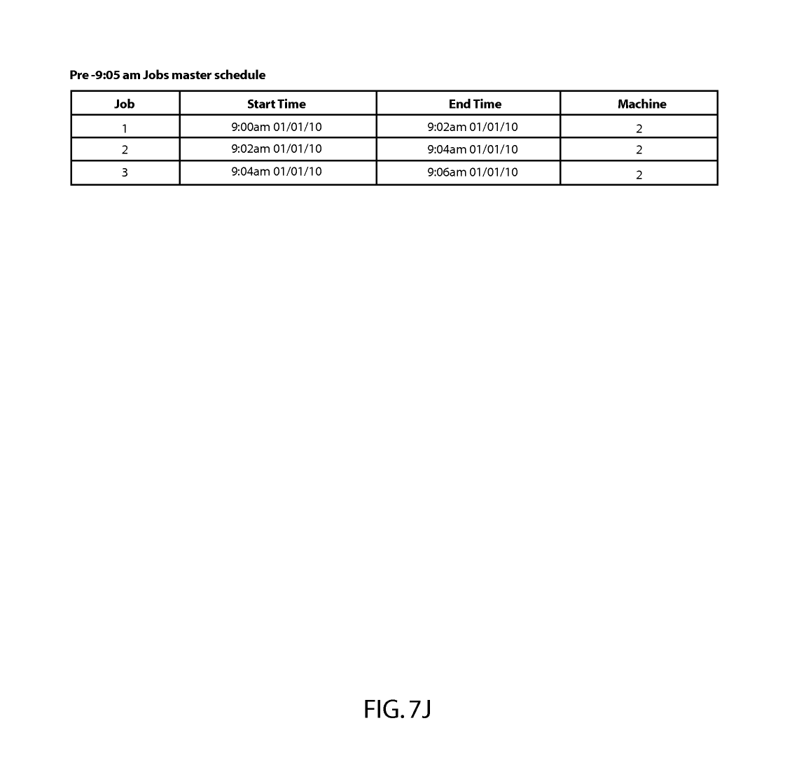

FIGS. 7A-7J illustrate examples for allocation of resources to real world activities by the finite schedule. Referring to FIG. 7A, consider two identical machines, machine 1 and machine 2. The machines can only process one job at a time. In this example, ten jobs arrive to the machines at a steady rate of one job per minute. Depending on which machine has a longer queue of waiting jobs, the jobs are assigned to a machine. The jobs take two minutes to complete, and are numbered 1 through 10. Jobs start arriving at 9 am on Jan. 1, 2010. One real world embodiment of this example would be a service station with two identical carwashes. 10 cars will arrive to these carwashes at a rate of 1 car per minute to be washed. The cars can only be processed in one of the two carwashes, and the carwashes can only process one machine at a time. A finite schedule in this setting is an allocation of cars, to carwashes, so that all the cars get washed and neither machine is washing two cars at once.

The finite scheduling method consists of allocating activities to resources. The method allocates each job to a machine as well as a proposed start time and duration for that job. The finite schedule is feasible for both machines, since neither machine is performing two jobs at the same time.

The example creates three master schedules, one for each carwash as well as a schedule for cars that arrive strictly before 9:05 am. The three master schedules are named as Machine 1, Machine 2, and Pre-9:05 am Jobs. FIGS. 7B-7D show the master schedules along with the unique identifier that is returned by the email/calendar platform.

As shown in FIGS. 7E-7F, consider at 9 am it is discovered that Machine 1 is broken, and will not be available until 10:00 am. A change is made to all the jobs on the Pre-9:05 am to change the time to 10:00 am. Similarly a change is made on the Machine 1 to change all the start times for those jobs to 10:01 am.

The proposed changes are infeasible, in the sense that for both master schedules they have moved a number of jobs to start at the same time, on the same machine. However, given that each carwash operator may not be able to see the other carwash machine, it is entirely likely that such a change may be made. Also, the two sets of proposed changes conflict, since one change is proposing a new start time of 10:00 am, and the other change is proposing 10:01 am. Using the methodology described above, the finite schedule is presented with proposed changes to activities on machine 1. FIGS. 7E-7F, show Jobs 1 and 3 only, although Jobs 1, 3, 5, 7, and 9 are all impacted. For each of the jobs, there are two proposed changes and the changes conflict. Also the changes are not feasible. Typically these changes must be resolved either by choosing one of the two calendars as the ‘correct’ value or choosing some other option to allow the finite scheduling algorithm to recalculate a feasible schedule.

A feasible schedule when applied by the finite scheduling algorithm is shown in FIG. 7G and FIGS. 7H-7J show the resulting updated master schedules. Again, the output is feasible for both machines, but takes into account the fact that machine 1 is unavailable until 10 am (after all the jobs have already been processed on machine 2). The updated times and allocations of activities to resources can then be published again to the E-mail/Calendar platform. As shown, the proposed changes by each carwash operator were infeasible (since they resulted either cars going to more than one carwash, or in a carwash doing more than one thing at once) after the reconciliation and update process the resulting two schedules are again feasible.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

I claim:

1. A method for real-time publishing of a feasible finite schedule comprising a plurality of activities and a plurality of resources, the method comprising the steps of:
(a) deriving at least one master schedule a, a=1 . . . A from an output of a finite schedule, the at least one master schedule comprising at least one master activity instance iₐ, iₐ=1 . . . Iₐ associated therewith;
(b) providing at least one published schedule b, b=1 . . . B associated with the at least one master schedule a, the at least one published schedule b including at least one published activity instance i_{b}, i_{b}=1 . . . I_{b} associated therewith;
(c) creating a schedule mapping table to store at least one relationship between the at least one master schedule a and the at least one published schedule b;
(d) creating an activity instance mapping table for the at least one master schedule a, the activity instance mapping table including at least one unique identifier to map the at least one master activity instance iₐ and the at least one published activity instance i_{b} in the at least one master schedule a and the at least one published schedule b;
(e) defining at least one property p, p=1 . . . P for the at least one master activity instance iₐ and the at least one published activity instance i_{b};
(f) iterating over each of the at least one master schedule a, a=1 . . . A and determining the existence of the at least one published schedule b by checking the schedule mapping table;
(g) creating a new published schedule if the at least one published schedule b does not exist in the schedule mapping table;
(h) iterating over each of the at least one master activity instance iₐ and iterating over each of the at least one published schedule b to determine if the at least one published activity instance i_{b} exists in the at least one published schedule b by checking the activity instance mapping table;
(i) creating a new published activity instance if the at least one published activity instance i_{b} does not exist in the at least one published schedule b and storing an entry iₐ/i_{b} in the activity instance mapping table for the at least one published schedule b;
(j) iterating over each of the at least one property p, p=1 . . . P for determining if the at least one property of the at least one master activity instance iₐ matches with the at least one published activity instance i_{b};
(k) altering the at least one published schedule b, the at least one published activity instance i_{b} and the at least one property p to match with the at least one master schedule a and registering an entry iₐ/i_{b} in the activity instance mapping table as not valid if the at least one property p of the at least one master activity instance iₐ does not match with the at least one published activity instance i_{b}; and
(l) registering the entry iₐ/i_{b} in the activity instance mapping table as valid if the at least one property p of the at least one master activity instance iₐ matches with the at least one published activity instance i_{b}.

2. The method of claim 1 wherein the publishing of the finite schedule allows the at least one master schedule to communicate with at least one device utilizing E-mail and Calendar platforms.

3. The method of claim 2 wherein the at least one device may be selected from a group consisting of a computer, a smart phone, a mobile phone and a mechanism adaptable to view the at least one master schedule a.

4. The method of claim 1 wherein each of the plurality of activities of the finite schedule includes a start date and time, end date and time, an activity name and the plurality of resources.

5. The method of claim 1 wherein the at least one unique identifier allows to map the at least one published activity instance i_{b} to a location on the at least one published schedule b.

6. The method of claim 1 wherein the schedule mapping table may include information to find the at least one published schedule b.

7. A method for real-time updating a finite schedule comprising a plurality of activities and a plurality of resources, the method comprising the steps of:
(a) deriving at least one master schedule a, a=1 . . . A from an output of a finite schedule, the at least one master schedule including at least one master activity instance iₐ, iₐ=1 . . . Iₐ associated therewith;
(b) providing at least one published schedule b, b=1 . . . B associated with the at least one master schedule a, the at least one published schedule b including at least one published activity instance i_{b}, i_{b}=1 . . . I_{b} associated therewith;
(c) creating a schedule mapping table to store at least one relationship between the at least one master schedule a and the at least one published schedule b;
(d) creating an activity instance mapping table for the at least one master schedule a, the activity instance mapping table including at least one unique identifier to map the at least one master activity instance iₐ and the at least one published activity instance i_{b} in the at least one master schedule a and the at least one published schedule b;
(e) defining at least one property p, p=1 . . . P for the at least one master activity instance iₐ and the at least one published activity instance i_{b};
(f) iterating over each of the at least one master schedule a, a=1 . . . A and determining the existence of the at least one published schedule b by checking the schedule mapping table;
(g) creating a new published schedule if the at least one published schedule b does not exist in the schedule mapping table;
(h) iterating over each of the at least one master activity instance iₐ and iterating over each of the at least one published schedule b to determine if the at least one published activity instance i_{b} exists in the at least one published schedule b by checking the activity instance mapping table;
(i) creating a new published activity instance if the at least one published activity instance i_{b} does not exist in the at least one published schedule b and storing an entry iₐ/i_{b} in the activity instance mapping table for the at least one published schedule b;
(j) iterating over each of the at least one property p, p=1 . . . P for determining if the at least one property of the at least one master activity instance iₐ matches with the at least one published activity instance i_{b};
(k) altering the at least one published schedule b, the at least one published activity instance i_{b} and the at least one property p to match with the at least one master schedule a and registering an entry iₐ/i_{b} in the activity instance mapping table as not valid if the at least one property p of the at least one master activity instance is does not match with the at least one published activity instance i_{b};
(l) registering the entry iₐ/i_{b} in the activity instance mapping table as valid if the at least one property p of the at least one master activity instance iₐ matches with the at least one published activity instance i_{b};
(m) iterating over each of the at least one published schedule b, b=1 . . . B and iterating over each of the at least one published activity instance i_{b}, i_{b}=1 . . . I_{b} in the activity instance mapping table to determine if the at least one published activity instance i_{b} is registered as not valid and exists in the at least one published schedule b;
(n) removing the at least one published activity instance i_{b} from the activity instance mapping table if the at least one published activity instance i_{b} is flagged as valid; and
(o) deleting the at least one published activity instance i_{b} from the at least one published schedule b and removing the at least one published activity instance i_{b} from the activity instance mapping table if the at least one master activity instance iₐ is fagged as not valid.

8. The method of claim 7 wherein the publishing of the finite schedule allows the at least one master schedule to communicate with at least one device utilizing E-mail and Calendar platforms.

9. The method of claim 8 wherein the at least one device may be selected from a group consisting of a computer, a smart phone, a mobile phone and a mechanism adaptable to view the at least one master schedule a.

10. The method of claim 7 wherein each of the plurality of activities of the finite schedule includes a start date and time, end date and time, an activity name and the plurality of resources.

11. The method of claim 7 wherein the at least one unique identifier to map the at least one published activity instance i_{b} to a location on the at least one published schedule b.

12. The method of claim 7 wherein the schedule mapping table may include information to find the at least one published schedule b.

13. A method for communicating at least one schedule deviation with a finite schedule comprising a plurality of activities and a plurality of resources at real-time, the method comprising the steps of:
(a) deriving at least one master schedule a, a=1 . . . A from an output of a finite schedule, the at least one master schedule including at least one master activity instance iₐ, iₐ=1 . . . Iₐ associated therewith;
(b) providing at least one published schedule b, b=1 . . . B associated with the at least one master schedule a, the at least one published schedule b including at least one published activity instance i_{b}, i_{b}=1 . . . I_{b} associated therewith;
(c) creating a schedule mapping table to store at least one relationship between the at least one master schedule a and the at least one published schedule b;
(d) creating an activity instance mapping table for the at least one master schedule a, the activity instance mapping table including at least one unique identifier to map the at least one master activity instance iₐ and the at least one published activity instance i_{b} in the at least one master schedule a and the at least one published schedule b;
(e) defining at least one property p, p=1 . . . P for the at least one master activity instance iₐ and the at least one published activity instance i_{b};
(f) iterating over each of the at least one master schedule a, a=1 . . . A and determining the existence of the at least one published schedule b by checking the schedule mapping table;
(g) creating a new published schedule if the at least one published schedule b does not exist in the schedule mapping table;
(h) iterating over each of the at least one master activity instance iₐ and iterating over each of the at least one published schedule b to determine if the at least one published activity instance i_{b} exists in the at least one published schedule b by checking the activity instance mapping table;
(i) creating a new published activity instance if the at least one published activity instance i_{b} does not exist in the at least one published schedule b and storing an entry iₐ/i_{b} in the activity instance mapping table for the at least one published schedule b;
(j) iterating over each of the at least one property p, p=1 . . . P for determining if the at least one property of the at least one master activity instance iₐ matches with the at least one published activity instance i_{b};
(k) altering the at least one published schedule b, the at least one published activity instance i_{b} and the at least one property p to match with the at least one master schedule a and registering an entry iₐ/i_{b} in the activity instance mapping table as not valid if the at least one property p of the at least one master activity instance iₐ does not match with the at least one published activity instance i_{b};
(l) registering the entry iₐ/i_{b} in the activity instance mapping table as valid if the at least one property p of the at least one master activity instance iₐ matches with the at least one published activity instance i_{b};
(m) iterating over each of the at least one published schedule b, b=1 . . . B and determining the presence of the at least one master schedule a for the published schedule b by checking the schedule mapping table;
(n) deleting the at least one published schedule b if the at least one master schedule a does not exist;
(o) iterating over each of the at least one published activity instance i_{b} in the at least one published schedule b if the at least one master schedule a exists;
(p) iterating over each of the at least one master schedule a, a=1 . . . A and determining if the entry iₐ/i_{b} exists in the at least one master schedule a by checking the activity instance mapping table;
(q) deleting the at least one published activity instance i_{b} from the at least one published schedule b if the entry iₐ/i_{b} does not exist in the at least one master schedule a;
(r) iterating over each of the at least one property p, p=1 . . . P if the entry iₐ/i_{b} exists in the at least one master schedule a;
(s) determining if the at least one property p matches for the at least one master activity instance iₐ and the at least one published activity instance i_{b};
(t) storing the at least one difference in the property of the at least one master activity instance iₐ and the at least one published activity instance i_{b} in a difference table Dₐ;
(u) iterating over each of the at least one master schedule a and iterating over each of the at least one master activity instance iₐ in the at least one master schedule a;
(v) iterating over each of the at least one property p to collect the at least one difference stored in the difference table Dₐ; and
(w) performing at least one action based on the at least one difference.

14. The method of claim 13 wherein the at least one action may be to accept the at least one difference if the at least one published schedule b shows a change from the at least one master schedule a.

15. The method of claim 14 wherein the at least one difference is accepted by updating the at least one master activity instance iₐ with the data from the at least one published activity instance i_{b}.

16. The method of claim 13 wherein the at least one action may be to reject the at least one difference if the at least one published schedule b shows the change from the at least one master schedule a.

17. The method of claim 16 wherein the at least one difference is rejected by deleting the activity instance mapping table.

18. The method of claim 13 wherein when there is no change issued from the at least one published schedule b then no change is made to the at least one master schedule a.
